(19) United States
(12) Patent Application Publication
(10) Pub. No.: US 2017/0023975 A1
(43) Pub. Date: Jan. 26, 2017

(54) AUDIO DOCKING

(71) Applicant: Hewlett-Packard Development Company, L.P., Houston, TX (US)

(72) Inventors: Saro Nalbandian, Palo Alto, CA (US); John William Pennington, JR., Mountain View, CA (US)

(21) Appl. No.: 15/302,246

(22) PCT Filed: Apr. 10, 2014
(86) PCT No.: PCT/US2014/033592

§ 371 Date: Oct. 6, 2016

(51) Int. Cl. G06F 1/16; H04R 1/02

(52) U.S. Cl. CPC G06F 1/1632; G06F 1/166; G06F 1/1626; H04R 1/028; H04R 2420/07

(57) ABSTRACT

In one example in accordance with the present disclosure, an audio docking device is provided. The audio docking device includes a speaker to produce sound in response to an input, and further includes a docking slot to receive and hold a kickstand of an electronic display device within the docking slot and enable a housing of the electronic display device to rotate relative to the audio docking device.

### BACKGROUND

Electronic displays such as liquid crystal displays (LCDs) and organic light emitting diode displays (OLEDs) are used in a plethora of systems to output content to viewers. For example, electronic displays are used in laptops, all-in-one computers, traditional desktop systems, retail point of sale systems, televisions, gaming systems, and the other similar systems to output content to viewers.

The electronic displays may be mounted or supported in numerous ways depending on the system type, intended use, and/or user preference. For example, a display associated with a traditional desktop computer system may be coupled to a stand that is situated on a flat surface. By contrast, a display associated with a television may be mounted to wall using a VESA mount. Moreover, a display associated with a laptop may be supported by the lower housing portion comprising a keyboard. Still further, some systems do not utilize a mount or support mechanism at all because the system is intended to be portable or handheld, such as the case with a smartphone or handheld gaming device.

### BRIEF DESCRIPTION OF THE DRAWINGS

Examples are described in the following detailed description and in reference to the drawings, in which:

FIGS. 1(a) and 1(b) depict an example system including an electronic display device and an audio docking device in accordance with an implementation of the present disclosure;

FIG. 2 depicts another perspective of the example audio docking device in accordance with an implementation of the present disclosure;

FIG. 3 depicts a block diagram of an example audio docking device in accordance with an implementation of the present disclosure;

FIG. 4 depicts an example kickstand with integrated electronic contacts in accordance with an implementation of the present disclosure; and

FIGS. 5(a) and 5(b) depict an example electronic display device docked to an audio docking device, where the electronic display and housing rotate relative to the audio docking device and kickstand in accordance with an implementation of the present disclosure.

### NOTATION AND NOMENCLATURE

Certain terms are used throughout the following description and claims to refer to particular system components. As one skilled in the art will appreciate, technology companies may refer to components by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection unless specified otherwise. Thus, if a first device couples to a second device, that connection may be through a direct electrical or mechanical connection, or through an indirect electrical or mechanical connection via other devices and connections. Additionally, the term “vertical” is intended to mean upright and approximately perpendicular to the plane of the horizon. Moreover, the term “horizontal” is intended to mean approximately parallel to the plane of the horizon. Still further, the term “kickstand” is intended to mean any suitable device or member that connects to a housing and deploys from the housing to support less than all of the weight of the housing when deployed. In addition, the term “all-in-one computer” is intended to refer to a single computing device that includes an electronic display, processing device, and computer-readable medium in one housing. Examples include all-in-one desktops computers, tablets, smartphones, smart displays, and combinations thereof.

Furthermore, the terms “docking slot” and “slot” are used interchangeably in the present disclosure to refer to an opening within a first device that enables a second device to be docked to the first device by inserting a portion of the second device in the docking slot.

### DETAILED DESCRIPTION

The following discussion is directed to various examples of the present disclosure. Although one or more of these examples may be preferred, the examples disclosed should not be interpreted, or otherwise used, as limiting the scope of the disclosure, including the claims. In addition, one skilled in the art will understand that the following description has broad application, and the discussion of any example is meant only to be descriptive of that example, and not intended to intimate that the scope of the disclosure, including the claims, is limited to that example

As mentioned above, electronic displays may be integrated in various computing systems to output content to viewers. As further mentioned, the electronic displays may be mounted or supported using numerous techniques depending on the system type, intended use, and/or user preference. For example, in some systems, the electronic display is located within a housing, and a kickstand is attached to the housing and utilized to support the housing in various orientations. More specifically, one portion of the kickstand is coupled to a back surface of the housing, and another portion of the kickstand rotates away from the housing to provide support when the housing is positioned on a surface. While this kickstand provides support for the housing, it generally does not provide other functionality to the system. Aspects of the present disclosure, therefore, attempt to increase the functionality and benefit of the kickstand by integrating various unique features into the kickstand and associated system components like an audio docking device. These novel and previously unforeseen architectures provide various benefits and are described in detail below with reference to various figures and example implementations.

In particular, in one example implementation, a system is provided. The system comprises an electronic display device and an audio docking device. The electronic display device includes a housing and a kickstand rotatably coupled to the housing. The audio docking device includes a speaker to produce sound in response to an input, and further includes a docking slot to receive and hold the kickstand of the electronic display device within the docking slot and enable the housing to rotate relative to the kickstand and audio docking device. In some implementations, by holding the kickstand within the docking slot, the housing of the electronic display device may be articulated to a vertical position, horizontal position, and/or angular position relative to a surface the audio docking device is situated on.

In a further example implementation, another system is provided. The system comprises an electronic display device and an audio docking device. The electronic display device includes a housing and a kickstand rotatably coupled to the housing. The audio docking device includes a speaker to produce sound in response to an input, and further includes a docking slot to receive and hold the kickstand of the electronic display device within the docking slot and enable the housing to rotates to at least a vertical position, horizontal position, or angular position relative to a surface the audio docking device is situated on. Moreover, the audio docking device is to provide power to the electronic display device via electronic contacts on the kickstand and within the docking slot, and further the electronic display device is to provide data to the audio docking device via the electronic contacts on the kickstand and within the docking slot.

In yet another example implementation, an audio docking device is provided. The audio docking device comprises a housing, a speaker to produce sound in response to an input, and a docking slot to receive a kickstand of an electronic display device. The docking slot is to hold the kickstand such that a housing of the electronic display device which is rotatably connected to the kickstand can rotate relative to the kickstand and the audio docking device. Furthermore, the audio docking device is to provide power to the electronic display device via electronic contacts within the docking slot.

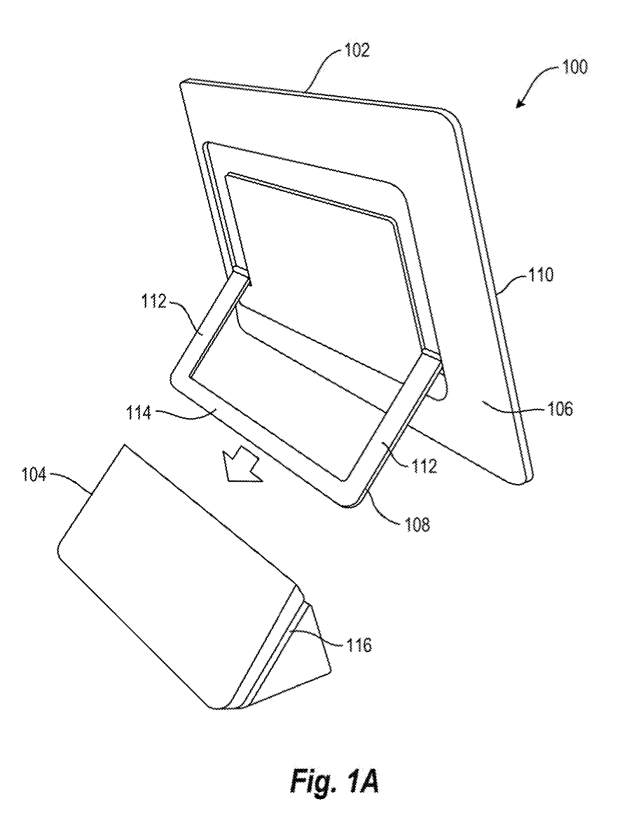

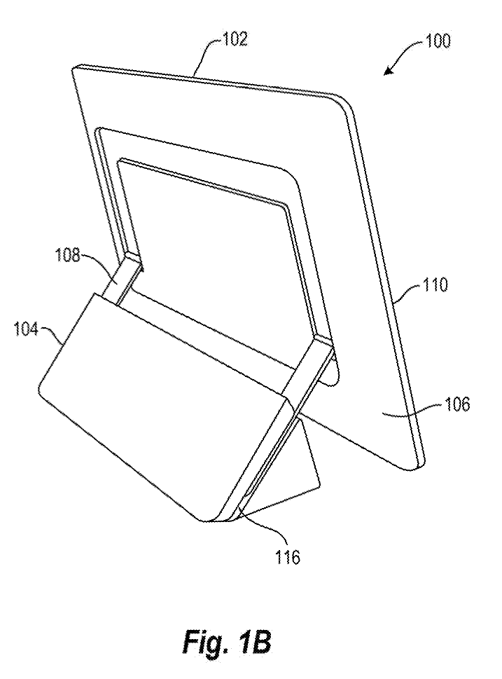

Turning now to FIGS. 1(a) and 1(b), these figures depicts a system 100 including an electronic display device 102 and an audio docking device 104 in accordance with an example implementation. It should be readily apparent that the system 100 represents a generalized illustration and that other elements may be added or existing elements may be removed, modified, or rearranged without departing from the scope of the present disclosure.

The electronic display device 102 may be, for example, an AiO computer (e.g., an all-in-one desktop computer, a tablet, a smartphone, or a smart display), a television, a display/monitor, and/or other similar devices comprising an electronic display 110. Among other components, the electronic display device 102 may comprise an electronic display 110 (not visible in FIGS. 1(a) and 1(b)), a housing 106, and a kickstand 108, each of which is described further below.

The electronic display 110 may be, for example, a liquid crystal display (LCD), plasma display, light emitting diode display (LED), organic LED display (OLED), thin film transistor display (TFT), super LCD, active matrix OLED, retina display, cathode ray tube (CRT), electroluminescent display (ELD), or another similar electronic display. In some implementations, the electronic display 110 may have a touch screen associated therewith (not shown). The touch screen may utilize hardware to detect input from a user's finger or stylus. For example, the touch screen may detect touch events touch using one of the following example touch technologies: a resistive touch panel, a capacitive touch panel, a surface acoustic wave touch panel, an infrared touch panel, an optical imaging touch panel, or a dispersive signal sensing touch panel.

The above-mentioned electronic display 110 and/or touch screen are located within the housing 106. Depending on the type of system 100, the housing 102 may formed of at least one material including, but not limited to, plastic, metal (e.g., steel, aluminum, etc.), rubber, and/or another material commonly used in electronic device housings.

The kickstand 108 is coupled to the housing 106. The kickstand 108 provides support for the electronic display device 102 when the electronic display device 102 is positioned on a surface (e.g., on a table or desk). At least one portion of the kickstand 108 is coupled to the housing 106, and another portion of the kickstand 108 extends away from the housing 106 when the kickstand 108 is being utilized. In the example shown in FIGS. 1(a) and 1(b), the kickstand 108 is rotatably coupled to the housing 106 such that the kickstand 108 may be fully retracted therein to allow the back face of the electronic display device 102 to be placed directly on a surface. That is, the kickstand 108 may be completely inserted in a recess within the housing 106 such that the back face of the electronic display device 102 appears flat and can lay substantially or completely flat on a surface. Furthermore, in the example shown in FIGS. 1(a) and 1(b), the kickstand 108 includes a pair of elongate support members 112 and an elongate cross member 114. Each of the support members 112 includes a proximal end and a distal end opposite the proximal end. The proximal end of each of the members 112 is rotatably coupled to the housing 106 via a shaft, while each of the distal ends extend outward from shaft. Cross member 114 generally includes a first end and a second end opposite the first end, and generally extends between the members 112 such that one end is coupled to the distal end of one of the members 112 while the other end is coupled to the distal end of the other member 112 relative to housing 106. While the present disclosure describes this particular kickstand arrangement, it should be understood that this is merely an example implementation and other kickstand arrangements may be utilized in accordance with various implementations of the present disclosure. For example, the kickstand 100 may differ in shape, size, and/or configuration from that shown in FIGS. 1(a) and 1(b) in various implementations.

Looking now at the audio docking device 104, this device is to produce sound in response to an input. In various examples, this input is received from the electronic display device 102 when docked to the audio docking device 104. For example, and as discussed further below, the electronic display device 102 may be docked to the audio docking device 104 (as shown in FIG. 1(b)) and may receive audio input from the electronic display device 102 via electrical contact points on the kickstand 108 and within the docking slot 116. Alternatively or in addition, the audio docking device 104 may receive audio input from the electronic display device 102 via wireless communication therebetween.

With regard to the composition, the audio docking device 104 may comprise a speaker, an amplifier, and an audio codec. Moreover, the audio docking device 104 may comprise additional components to provide enhanced features such as a processing device, a computer-readable medium (e g., storage/memory), a network interface, a rechargeable battery, an input/output (I/O) interface, and a bus to connect the various components.

In addition to the above, the audio docking device 104 includes a docking slot 116 to receive the kickstand 108 of the electronic display device 102. In particular, when the kickstand 108 is inserted into the slot 116 (as shown in FIG. 1(b)), the slot 116 holds the kickstand 108 firmly in place. The slot 116 may accomplish this firm hold in various ways. For example, the slot 116 may taper such that the opening portion which initially receives the kickstand 108 is wider than the ending portion closer to the base of the audio docking device 116. As such, a pressure/friction fit occurs when the kickstand 108 is inserted in the slot 116 and the kickstand cross member 114 approaches the base of the audio docking device 116. Alternatively or in addition, a fastening mechanism such as a clamp, latch, and/or lock may be utilized to hold the kickstand 108 firmly in place within the slot 116.

As discussed further below, coupling the electronic display device 102 to the audio docking device 104 via the slot 116 and kickstand 108 enables numerous functionalities to occur in accordance with various implementations of the present disclosure. For instance, in one example, electrical contact points on the kickstand 108 and slot 116 enable data and/or power to be transmitted to/from the audio docking device 104 and electronic display device 102. Such a data transfer may enable audio data received from the electronic display device 102 to be output via the speaker within the audio docking device 104. Moreover, data received from the electronic display device 102 may be stored within a computer-readable medium (e.g., SSD, HDD, flash memory, etc.) for backup/synchronization purposes. In addition, a power transfer from the audio docking device 104 to the electronic display device 102 may enable the electronic display device 102 to obtain its operating/charging power from the audio dock 104. Still further, because the kickstand 108 may be rotatably connected to the housing 106 and because the kickstand 108 is firmly held by the slot 116, the housing 106 and electronic display 110 portions may rotate relative to the audio docking stand 104 and kickstand 108. Hence, the housing 106 and electronic display 110 therein may be rotated to a vertical position, horizontal position, and/or angular position relative to a surface the audio docking device 104 is situated on to provide the user with a flexible viewing experience.

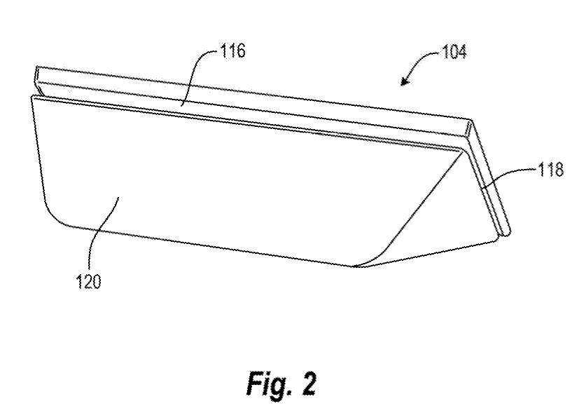

Looking now at FIG. 2, this figure depicts the audio docking device 104 from another perspective. As can be seen from this perspective, the audio docking device 104 may be a substantially triangular shape, and the slot 116 may extend across the audio docking device 104 and down close to the base of the audio docking device 104. In some implementations, the side portions 118 of the slot 116 may remain open like shown in FIGS. 1 and 2. As a result of these open sides, the slot 116 may accommodate various size kickstands 108, including kickstands 108 that are wider than the slot 108 and extend outside of the audio docking device 104. In other implementations, the side portions 118 of the slot 116 are closed, and therefore do not accommodate kickstands 108 that are wider than the audio docking device 104.

In various implementations, the audio docking device 104 is weighted down such that it can support the electronic display device 102 in various viewing positions without tipping over. In some examples, the weighting is accomplished by including weighted material at the base portion of the audio docking device 104.

Although not apparent in FIG. 2, the front face 120 of the audio docking device 104 may include a grill or porous portion 120 to enable sound from the internal speaker to emerge from the audio docking device, 120. This speaker may be, for example, at least one of a full ranger driver, subwoofer, woofer, mid-range driver, coaxial driver, and tweeter.

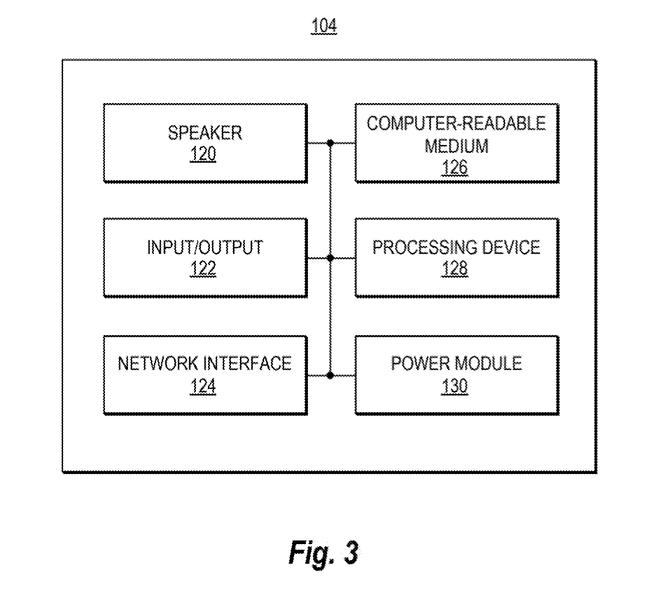

Turning now to FIG. 3, this figure depicts a block diagram of an example audio docking device 104 in accordance with an implementation of the present disclosure. As shown, the audio docking device 104 comprises a speaker 120, input/output component 122, network interface 124, computer-readable medium 126, processing device 128, and power module 130. The speaker 120 may comprise a full range driver, subwoofer, woofer, mid-range driver, coaxial driver, and/or tweeter. The input/output component 122 may comprise a USB port, Ethernet port, serial port, parallel port, VGA port, HDMI port, DisplayPort, and/or another input/output component commonly associated with a docking station. Further, the input/output component 122 may comprise a port to receive a memory card, such as a SD card. The network interface 124 may comprise a wired and/or wireless network interface. For example, the network interface 124 may comprise a short range wireless interface (e.g., Bluetooth, NFC, etc.), a long range wireless interface (e.g., IEEE 802.11), and/or a wired network interface (e.g., Ethernet). The computer-readable medium 126 may comprise a component that stores programming instructions and/or data. For example, the computer-readable medium 126 may comprise a non-volatile memory (e.g., EEPROM, ROM, Memristor, Flash, etc.), a volatile memory (e.g., DRAM, SRAM, etc.), and/or a storage device (e.g., HDD, SSD, hybrid drive, etc.). The processing device 128 may comprise a device that retrieves and executes instructions, such as a CPU, GPU, microprocessor, microcontroller, or other similar processing devices that execute instructions. The power module 130 may comprise circuitry and/or components to provide power to the audio docking device 104 and/or electronic display device 102. The power module 130 may comprise, for example, an AC/DC converter, a regulator, a rechargeable battery, and/or an uninterruptible power supply (UPS) circuit.

The above-discussed components of FIG. 3 operate together to provide various functionalities to the audio docking device 104 and/or electronic display device 102. For example, the audio docking device 104 may function as a “personal cloud,” where the computer-readable medium stores data received from the electronic display device 102. The received data may comprise all data types including, but not limited to, audio content, video content, images, documents, files, and/or other types of data commonly stored on electronic display devices 102. This data may be received via a direct coupling between the audio docking device 104 and the electronic display device 102 (e.g., via electronic contacts in the slot 116 and on the kickstand 108), or via an indirect coupling between the audio docking device 104 and the electronic display device 102 (e.g., via wireless communication using the network interface 124). In some examples, data from the electronic display device 102 is synchronized and/or stored within the computer-readable medium 126 of the audio docking device 104 in response to the kickstand 108 being inserted into the slot 116. In other examples, data from the electronic display device 102 is periodically synchronized and/or stored within the computer-readable medium 126 via the above-mentioned direct or indirect coupling approaches.

In further examples, in response to the electronic display device 102 being docked to the audio docking device 104, audio content is output via the speaker 120. Depending on the implementation, the audio content may or may not have been output by the electronic display device 102 prior to docking. For example, in response to docking, audio content that was previously being output by the electronic display device 102 may be automatically output via the speaker 120 associated with the audio docking device 104. In another example, a manual trigger is required to cause the audio content to be output via the speaker 120 (e.g., the user pressing a command on an interface associated with the electronic display device 102). Further, in some examples, audio content is output by the audio docking device 104 and the electronic display device 102 at the same time, while in other examples, audio content is only output by the audio docking device 104.

In additional examples, the power module 130 provides various power-related functionalities to the audio docking device 104 and/or electronic display device 102. In one example, the power module 130 provides operating/charging power for the audio docking device 104 only. In another example, the power module 130 provides operating/charging power to both the audio docking device 104 and electronic display device 102. The power may be received by the audio docking device 104 via an integrated power adapter/cord that plugs into an AC wall receptacle. Alternatively, the audio docking device 104 may be configured such that the power adapter associated with the electronic display device 102 may be plugged into the audio docking device 104, and the audio docking device 104 may relay the power to the electronic display device 102 via the electronic contacts. In another example, the audio docking device 104 may include a recess/cavity to hold the power adapter associated with the electronic display device 102, and one end of the power adapter plugs in a wall receptacle and the other end plugs directly into the electronic display device 102.

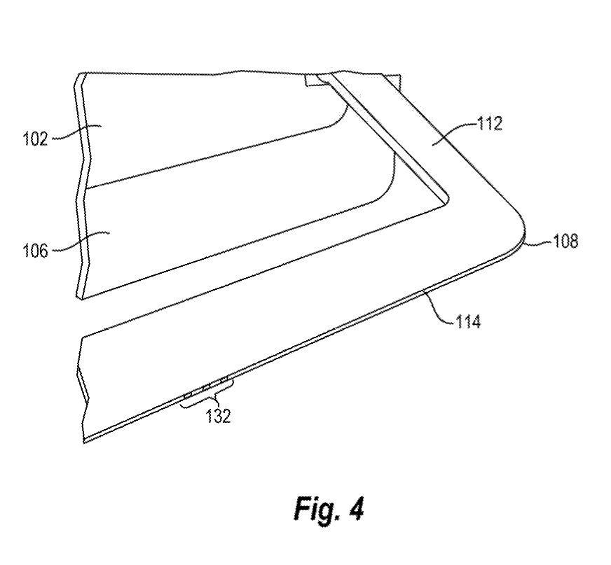

Turning now to FIG. 4, this figure depicts an example kickstand 108 with electronic contacts 132 in accordance with aspects of the present disclosure. More specifically, FIG. 4 depicts an enlarged image of a kickstand 108 where electronic contacts 132 are located on the cross member portion 114. As discussed above, these electronic contact points 132 may mate with corresponding electronic contact points in the slot 116 of the audio docking device 102 to transfer data and/or power to/from the devices. It should be understood that while three contact points 132 are shown in the center of the cross member 114, other variations may also be utilized in accordance with various implementations of the present disclosure. For example, the electronic contact points 132 may be located in a different position on the kickstand 108 and/or a different amount or different type of contact points 132 may be utilized.

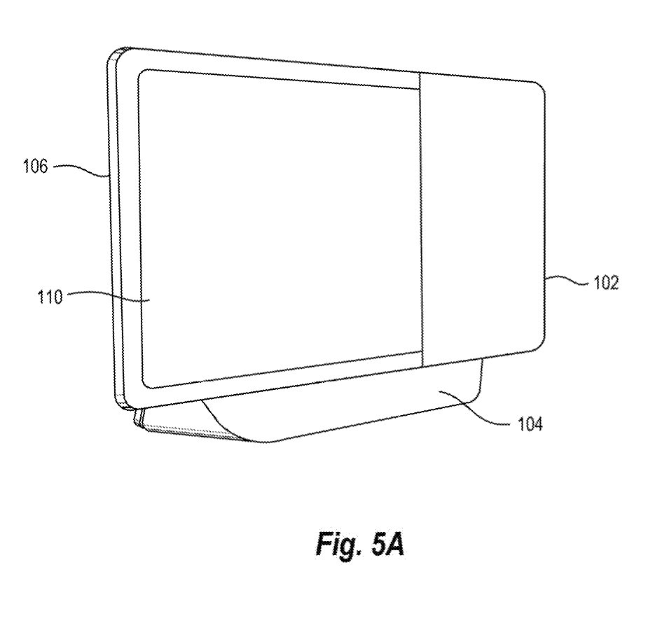

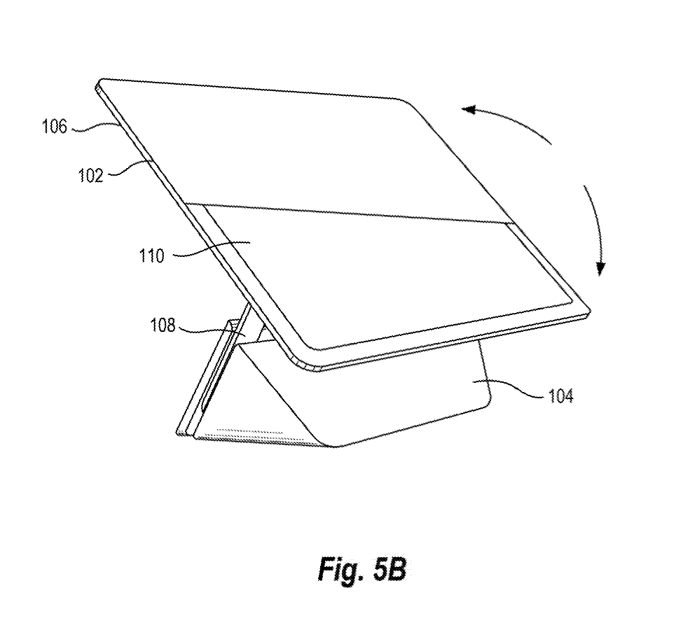

Looking now at FIGS. 5(a) and 5(b), these figures depict an example electronic display device 102 docked to an audio docking device 104, where the electronic display 110 and housing 106 rotate relative to the audio docking device 104 and kickstand 108. More specifically, because the kickstand 108 is rotatably coupled to the housing 106 and held firmly in place by the audio docking device 104, the housing 106 and electronic display 110 therein may rotate to various viewing angles without moving the audio docking device 104 and without tipping over. For example, and as shown in FIG. 5(a), the housing 106 and electronic display 110 may be rotated to a vertical position relative to a surface the audio docking device 104 is situated on. This vertical position may be substantially perpendicular to the surface the audio docking device 104 is situated on. Alternatively, the housing 106 and electronic display 110 may be rotated to a horizontal position relative to a surface the audio docking device 104 is situated on. This horizontal position may be substantially parallel to the surface the audio docking device 104 is situated on. Furthermore, and as shown in FIG. 5(b), the housing 106 and electronic display 110 may be rotated to an angular position relative to a surface the audio docking device is situated on. The angular position may be, for example, any angle between the above-mentioned vertical and horizontal positions, or in some examples, beyond the horizontal position such that the electronic display faces backwards (i.e., the electronic display 110 face opposite the direction shown in FIG. 5(a).

In some implementations, the range of motion of the housing 106 and electronic display 110 may be limited by an internal stopping mechanism when the electronic display device 102 is not docked. For example, to reduce the potential of tipping over when not docked, the housing 106 and electronic display 110 may be limited from reaching a substantially vertical position. Thus, when used as a standalone device and not docked, the housing 106 and electronic display 110 may sit at an angle and not reach a substantially vertical position when the kickstand is deployed. Because this is less of a concern when docked due to the weight of the audio docking device 104, in some implementations, the audio docking device 104 includes a mechanism to temporarily disable the stopping mechanism of the electronic display device 102, and therefore allow the housing 106 and electronic display 110 to reach a substantially vertical position with respect to the surface the audio docking device 104 is situated on. In some implementations, temporarily disabling the stopping mechanism of the electronic display device 102 allows the housing 106 and electronic display 110 to reach a forward tilt position (i.e., forward tilting beyond the vertical position shown in FIG. 5(a)).

The foregoing describes a novel and previously unforeseen approach to enable an audio docking device to provide additional functionality to a user. In particular, by at least providing a slot to receive a kickstand of an electronic display device, functionalities related to transferring data, transferring power, synchronization, housing/display rotation, and other functionalities discussed above can be achieved. While the above disclosure has been shown and described with reference to the foregoing examples, it should be understood that other forms, details, and implementations may be made without departing from the spirit and scope of the disclosure that is defined in the following claims.

What is claimed is:

1. A system, comprising:
an electronic display device including a housing and a kickstand rotatably coupled to the housing; and
an audio docking device including a speaker to produce sound in response to an input, and further including a docking slot to receive and hold the kickstand of the electronic display device within the docking slot and enable the housing to rotate relative to the kickstand and the audio docking device.

2. The system of claim 1, wherein the audio docking device is to provide power to the electronic display device via electronic contacts on the kickstand and within the docking slot.

3. The system of claim 1, wherein the electronic display device is to provide data to the audio docking device via electronic contacts on the kickstand and within the docking slot.

4. The system of claim 1, wherein the audio docking device further comprises a network interface, and wherein the audio docking device is to wirelessly communicate with the electronic display device via the network interface.

5. The system of claim 1, wherein the docking slot is further to receive and hold the kickstand of the electronic display device within the docking slot and enable the housing to rotate to a vertical position, horizontal position, or angular position relative to a surface the audio docking device is situated on.

6. The system of claim 1, wherein the audio docking device further comprises a computer-readable medium, and wherein the audio docking device is to receive data from the electronic display device and store the data on the computer-readable medium.

7. The system of claim 1, wherein the electronic display device comprises an all-in-one (AiO) computer.

8. The system of claim 1, wherein the docking slot is to receive and hold different width kickstands.

9. The system of claim 1, wherein the audio docking device further comprises a cavity to hold a power adapter, and wherein the power adapter is to provide power to at least the electronic display device.

10. An audio docking device, comprising:
a housing;
a speaker to produce sound in response to an input; and
a docking slot within the housing to receive a kickstand of an electronic display device,
wherein the docking slot is to hold the kickstand such that a housing of the electronic display device which is rotatably connected to the kickstand can rotate relative to the kickstand and the audio docking device, and
wherein the audio docking device is to provide power to the electronic display device via electronic contacts within the docking slot.

11. The audio docking device of claim 10, wherein the audio docking device is further to receive data from the electronic display device via the electronic contacts within the docking slot.

12. The audio docking device of claim 10, wherein the audio docking device comprises at least one of an input/output interface, a computer-readable medium, a network interface, and a rechargeable battery.

13. The audio docking device of claim 10, wherein the audio docking device is to communicate wirelessly with the electronic display device.

14. The audio docking device of claim 10, wherein the docking slot is to receive and hold different width kickstands.

15. A system, comprising:
an electronic display device including a housing and a kickstand rotatably coupled to the housing; and
an audio docking device including a speaker to produce sound in response to an input, and further including a docking slot to receive and hold the kickstand of the electronic display device within the docking slot and enable the housing to rotate to at least a vertical position, horizontal position, or angular position relative to a surface the audio docking device is situated on,
wherein the audio docking device is to provide power to the electronic display device via electronic contacts on the kickstand and within the docking slot, and
wherein the electronic display device is to provide data to the audio docking device via the electronic contacts on the kickstand and within the docking slot.
